(19) United States
(12) Patent Application Publication
(10) Pub. No.: US 2008/0087725 A1
(43) Pub. Date: Apr. 17, 2008

(54) Fixture based Item Locator System

(76) Inventor: Qing Liu, Arlington, VA (US)

Correspondence Address: WILSON DANIEL SWAYZE, JR., 3804 CLEARWATER CT., PLANO, TX, 75025, US

(21) Appl. No.: 11/548,372

(22) Filed: Oct. 11, 2006

(51) Int. Cl. G06F 19/00

(52) U.S. Cl. 235/385

(57) ABSTRACT

An item locator system including a computer responsive to the commands of a user of the computer corresponding to a location of a plurality of items within an establishment, the establishment including a plurality of display fixtures identifiable using identification codes, the computer having access to stored data comprising information regarding the location of the plurality of items within the establishment, the computer upon receiving a request from the user displays the identification codes of the display fixtures where the plurality of items can be found.

### BACKGROUND OF THE INVENTION

1. Field of the Invention

The present invention relates to providing customer self-service functions in establishments such as libraries and retails stores. In particular, the invention allows a customer to find the physical locations of items inside an establishment by finding the display fixture containing the item using identification codes.

2. Description of the Prior Art

Establishments such as libraries and retail stores typically have tens of thousands of items in stock. These items are placed on display fixtures such as shelves, bins, pegboards, slat wall, grid wall, racks, hangers, showcases, gondolas, and tables. The patrons visiting these establishments and looking for specific items often find it difficult to locate the items that they are looking for inside the establishment. These patrons will then ask the employees where to find the item that they're looking for. However, this can often prove to be time-consuming and frustrating for the patrons. Therefore, there is need for an automated system to help these patrons find the exact locations of items inside a store.

Some retail stores print or display within the store a list of item categories along with their aisle numbers. However, this method is difficult to use because only a limited number of categories are displayed. The categorization of retail items is a highly specialized and complicated field. Many items can belong to multiple categories. Different stores categorize items in different ways. These categories do not help the customers since most customers do not know which category an item might belong to, particularly for items they don't buy frequently. Furthermore, this method only provides an aisle number for each category listed, so even if a customer knows which category an item belongs to, he or she still has to wander around the aisle to find the item. For large stores, there can be hundreds of different items within one single aisle. So customers still will have difficulty to locate items even if they know the aisle number.

U.S. Pat. No. 5,047,614 issued Sep. 10, 1991 to Bianco describes a method and apparatus for computer aided shopping. The method includes a portable bar code scanner having an electronic memory for the use by a consumer. The consumer enters desired items into the memory by scanning the bar code of the items such as containers, coupons, advertisements, and pamphlets furnished by a store. The system of this invention creates a shopping list from the input items. This invention, although provides ways to make customers' shopping experience more efficient, it also adds complexity to the process by requiring the customer to lease or purchase a portable bar code scanner with an electronic memory. In addition, customers frequently do not have printed barcodes available for the items they want to purchase, and therefore will not be able to use the system.

U.S. Pat. No. 6,000,610 issued Dec. 14, 1999 to Talbott et al. describes a store specific shopping system to improve the shopping experience for retail customers using a portable map and shopping list. The printed portable map serves both as a shopping list for selecting articles for purchase and as an in-store directory for locating selected articles. The map is essentially a pictorial representation of items in the form of a store map to show their locations in the store. It includes a written index adjacent to a pictorial representation of a product. Although this invention to some extent can help customers locate items, the number of items that can be displayed on such maps as described in the invention is very limited. The map become clustered and difficult to read when there are more than twenty items in an aisle.

U.S. Pat. No. 6,442,530 B1 issued Aug. 27, 2002 to Miller describes a self-service kiosk system for mapping and conveying product location to retail customers. The system retrieves product location information from an in-store computer system and then depicts a path from the kiosk towards the product location. This invention tries to apply mapping and way-finding techniques commonly used in Geographic Information Systems (GIS) to help customers inside a retail store. However, when customers have difficulty finding items in a store, the problem they have is they don't know where the item is located rather than how to get there. Given the location of an item, most people will not have trouble finding the location.

U.S. Pat. No. 6,533,173 B2 issued Mar. 18, 2003 to Benyak describes a product locator system to permit a customer using a portable personal shopping device to receive product location and price information from a store computer. This invention relies on items being placed on shelves that are arranged in aisles. The system of this invention provides item location information in the format of aisle, side of aisle, and shelf.

U.S. Pat. No. 6,609,317 issued Aug. 26, 2003 to Myers describes a two part indexing and signage system for use with shopping carts and store aisles. The first part includes a general indexing system attached to a shopping cart. The second part is in connection with the shelving typically containing the products, the aisle of the store and contains an alphanumerical key having three characters associated with each item in order to identify particularly product positions within that aisle. In order to find an item, according to this system, a customer will first use the first part to identify the aisle, then go to the aisle and look for the second part. The disadvantages of this system include its indirection and the complication of the three-alphanumerical key coding to represent location. In addition, customers may find it difficult to determine the aisle number for the item they are looking for using the first part of the system, which, according to the invention, is an index sheet that shows general description of items and the aisle numbers.

U.S. Pat. No. 6,757,999 B2 issued Jul. 6, 2004 to Jurgens et al. describes a stock locator system utilizing three indices to define item locations: A first indicia to designate a bay within a retail environment, a second indicia to designate a shelf within that bay, and a third indicia to designate a location within that shelf. This invention is designed to help employees locate items wherein storage locations are arranged in bays and shelves.

U.S. Pat. No. 6,813,341 issued Nov. 2, 2004 to Mahoney describes an item locator system which relies upon voice activation and responsiveness to identify location(s) of item(s) sought by a user.

U.S. Pat. No. 7,010,498 issued Mar. 7, 2006 to Berstis describes a method for providing a location of products to a customer in a retail environment. In this invention, a product locator unit is attached to a shopping aid utilized within the retail environment.

U.S. Pat. Application Pub. No. 2002/0138372 A1 by Ludtke published Sept. 26, 2002 describes a system for locating items by broadcasting multiple product class names and their locations to remote devices such as PDAs. The remote device compares the broadcasted product class names with pre-stored product list, and display any matches. Such match can be difficult to reach. One reason is in the products typically can belong to multiple classes and the product names seldom matches the product class names. The terms used by customers in their shopping list frequently are different from what stores use to name their product classes. With the limited storage and display capability in PDAs, customers using these PDAs frequently use abbreviations when creating shopping lists, these abbreviations can differ from customer to customer, and this makes it even less likely to find matches with the product names broadcasted by stores.

U.S. Pat. Application Pub. No. 2002/0178013 A1 by Hoffman et al. published Nov. 28, 2002 describes a computer-based system that guides a customer to the location of a product in retail store. With this system, the customer enters a product code corresponding to the item that the customer is interested in and receives the location of the item. According to this invention, the product code can usually be found from printed catalogs and coupons. However, in many cases when a customer wants to find an item at a store, they are looking for an item out of need rather than seeing the item in a catalog. Frequently, customers do not have product codes readily available when they look for things. For instance, a customer who needs to find a screw driver will not know the product code for screw driver, since there are many different brands and types of screw drivers, possibly each with different product codes.

U.S. Pat. Application Pub. No. 2002/0099560 A1 by Enfield published Jul. 25, 2002 describes a system for guiding and orienting shoppers with regard to a product location in a retail store. The system places graphical signs that are representative of the products at various aisle locations. Comparing to tradition word-only store signs, this invention provides a more intuitive way to convey the category of items in each aisle; however, it suffers space limitations as each sign can only show a limited number of products for that aisle. Examples shown in the application typically has four to five items for each side of an aisle. Yet many aisles in typical retails stores have tens to hundreds of different item types. Customers will not be able to know the locations for items that are not represented in the graphical signs.

U.S. Pat. Application Pub. No. 2003/0136831 A1 by Alford published Jul. 24, 2003 describes a multi-page tablet with each page having a map of the store. This invention uses similar method to that described by Talbott to show products in a pictorial store map.

### SUMMARY OF THE INVENTION

The present invention allows patrons or users to locate items using identification codes for display fixtures coupled with a computer. The patron enters a request for item location using the computer. The system searches its data store to locate the item and outputs the identification codes of the display fixtures containing the items. The output may also include a map with the locations of display fixtures marked.

### BRIEF DESCRIPTION OF THE DRAWINGS

The invention may be understood by reference to the following description taken in conjunction with the accompanying drawings, in which, like reference numerals identify like elements, and in which:

FIG. 1 shows the system of the present invention using client-server application architecture;

FIG. 2 illustrates a plan view of the store in the server;

FIG. 3 shows the data structure of the data store in a particular implementation;

FIG. 4 is a flow chart view of the overall process to complete an item location search;

FIG. 5 illustrates the process of query parsing and cooking;

FIG. 6 illustrates the item retrieval process;

FIG. 7 illustrates the front view of a particular display fixture.

### DETAILED DESCRIPTION OF THE PREFERRED EMBODIMENT

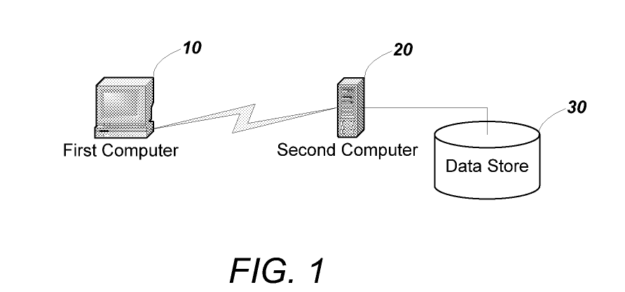

FIG. 1 shows the system implemented using client-server application architecture. The system comprises client computer 10, server computer 20, and data store 30. The client computer 10 is typically a personal computer; however, it can be a handheld device or other types of communication-enabled appliance capable of communicating with another computing device. The server computer 20 is capable of handling network requests. The client 10 and the server 20 have an apparatus to communicate with each other. This communication can be established through a local area network, a wide area network, a wireless network, or other ways of communication. The server 20 has access to data store 30. The data store 30 includes an apparatus to store and retrieve structured information. The data store 30 can be a relational database, an object-oriented database, data files, other types of information storage and retrieval system, or a combination of different types of information systems.

The client computer 10 includes programs to handle user interactions. The client computer 10 is capable of receiving inputs from the customer/user, transmitting the request to the server 20, receiving a response from server 20, and displaying the results to the customer.

For description purposes, the first computer 10, the second computer 20, and the data store 30 are shown as three separate components. However, in implementation, all three components or any two components can be physically located in one or two computers.

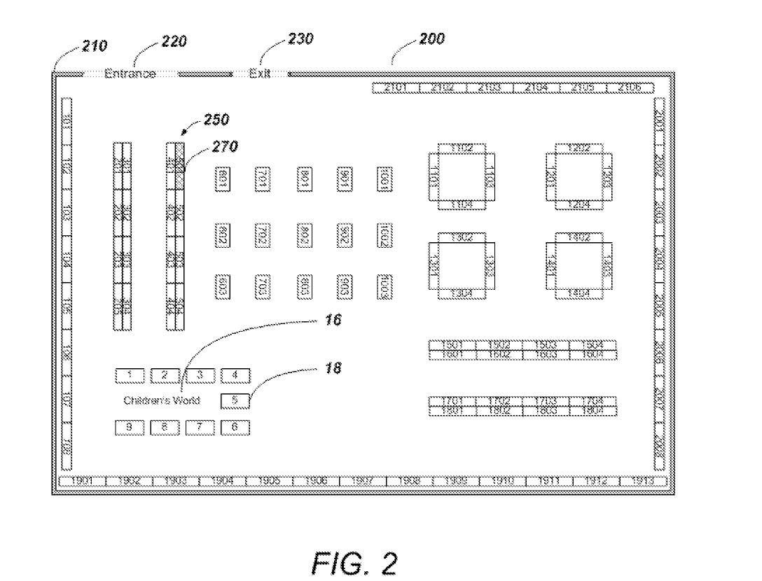

FIG. 2 shows an example of a store map 200 which includes the basic features of an establishment with display fixture set 250. A display fixture can be a single hardware such as a shelf, a slat wall, a grid wall, a rack, a hanger stand, a showcase, a gondola, or a table. A fixture can also be a plurality of the hardware arranged in close physical proximity or a combination of the above described fixtures.

Refer now to FIG. 2.

Reference numeral 210 indicates the boundary of the establishment. Reference numeral 220 indicates the entrance. Reference numeral 230 indicates the exit. Reference numeral 250 indicates a display fixture set. A display fixture set is a group of connected display fixtures. Reference numeral 270 indicates a highlighted display fixture within the display fixture set 250.

In order to make it easier for customers to identify a display fixture in the store map, it will be helpful to put a label on each fixture. The labels should be large enough for easy reading. The texts of the labels should form a noticeable trend, so that customers can easily navigate by the labels and located the display fixture containing the items they look for.

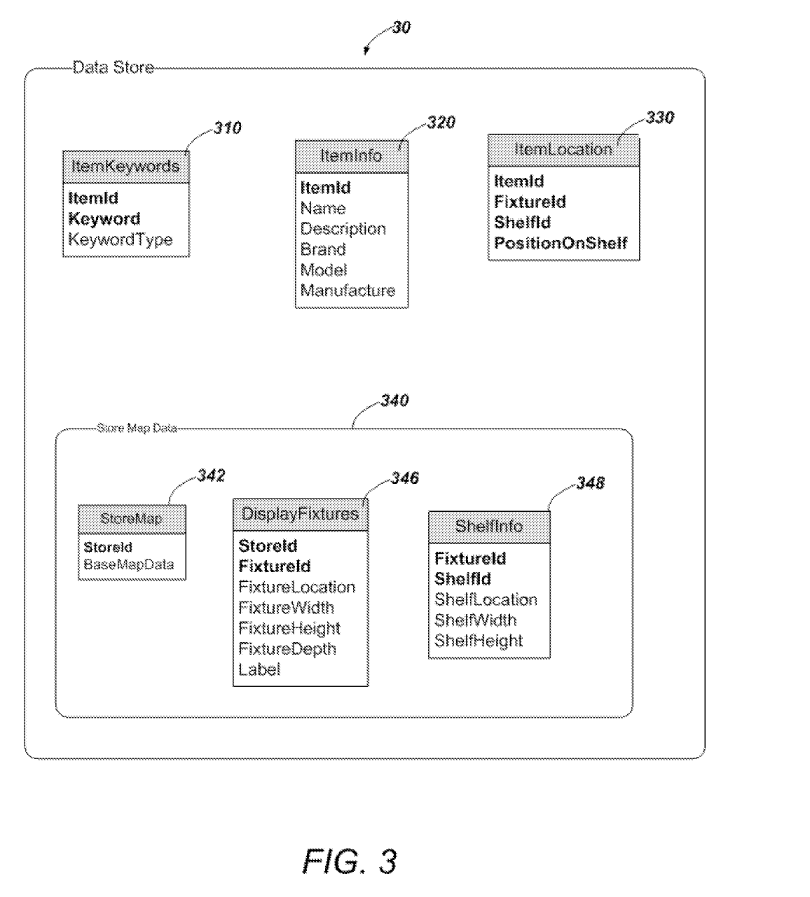

FIG. 3 illustrates the information stored in data store 30. Shown in this figure are the core tables with their name and columns. Bolded column names indicate the keys.

Refer now to FIG. 3.

The ItemKeywords table 310 stores the keywords for each item. For each item, there can be one or more keywords. Each keyword has a type attribute. The type indicates the nature of the keyword, i.e., whether the keyword describes the name, brand, category, or other aspects of an item.

The ItemInfo table 320 stores item data such as name, description, brand, and model. This information will be displayed to the customer so that the customer can determine whether the item is what he is looking for.

ItemKeywords table 310 and ItemInfo table 320 are closely related. Normally data in the ItemKeywords table 310 are derived from the ItemInfo table 320. However, item keywords should not be word for word reproduction of what are in the item names or descriptions. Instead, only those words and phrases that are representative of the item should be used as the keywords.

An alternative way to store item keywords information is using index files instead of database tables.

The ItemLocation table 330 stores the location for each item. Item location includes the fixture and the shelf that the item is placed on, and optionally the position for the item within the shelf. The position can be expressed as either the horizontal and vertical coordinates or simply a sequence number indicating the order of the item on the shelf.

Store map data 340 contains three tables. The StoreMap table 342 stores the base map for the store. The DisplayFixtures table 346 stores the location and dimensions for display fixtures. The locations of the display fixtures are their coordinates in the store map. The location and dimensions together determine the position and shape of the display fixture on map. The DisplayFixtures table 346 also contains a FixtureLabel column. This column can be used to store label values for each display fixture, so that a label can be shown inside the display fixture on the map. The purpose of labeling the display fixtures is to help customers easily identify each display fixture and locate them on the map and in actual store. The label value should generally be unique for each fixture within the fixture set and should be easily identifiable.

The Shelfinfo table 348 is used to store vertical location and dimensions for each shelf. The location of a shelf is the vertical coordinates of the shelf on the display fixture. The dimensions include the width and height of the shelf. Depth may also be stored in this table if needed. This information can be used to draw a front view of the display fixture.

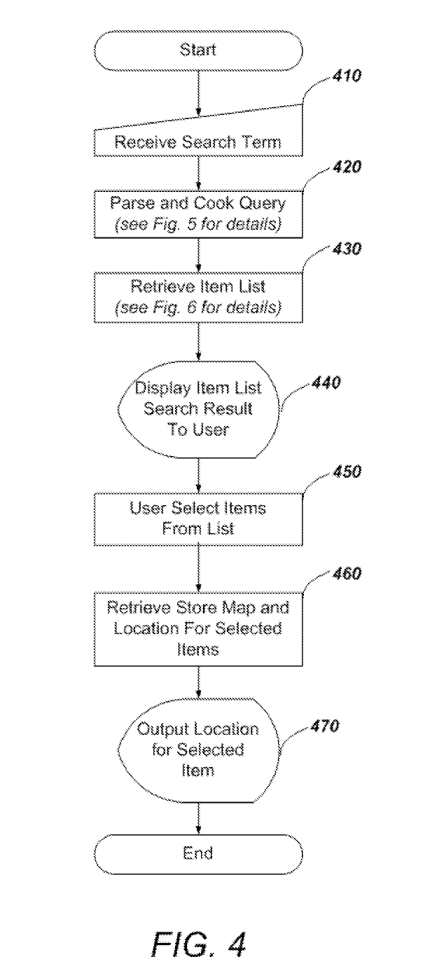

FIG. 4 shows the process for completing an item location search process. This flow chart diagram outlines the steps to complete an item location search process. It should be understood that the process involves both the client computer 10 and the server 20. Some steps of the process will be executed at the client computer 10 while other steps at the server computer 20.

Refer now to FIG. 4.

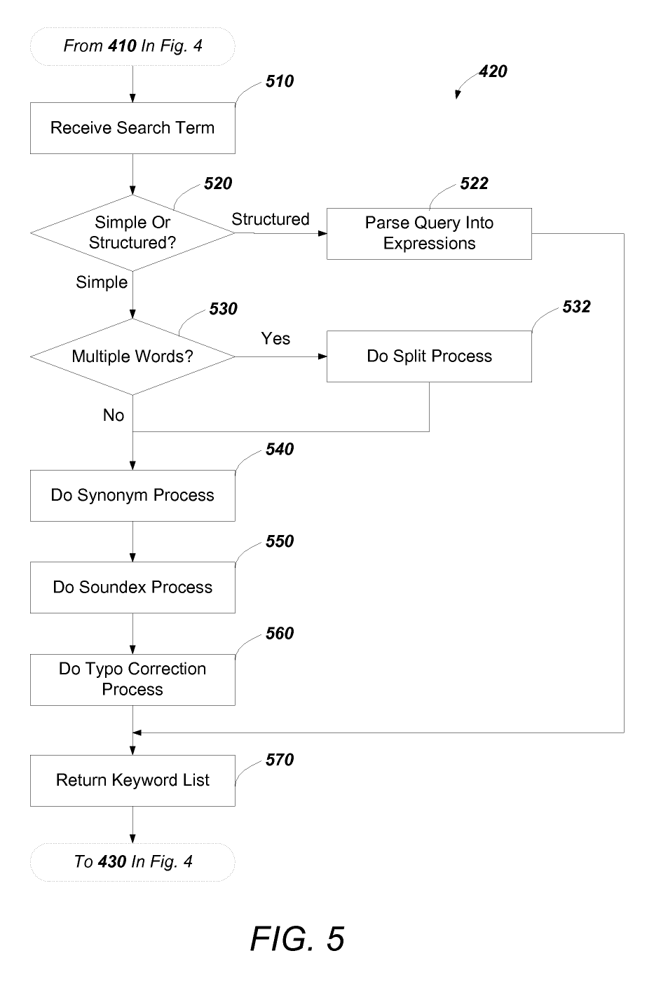

A search process starts with block 410, when the customer submits a search term at the client computer 10. The client computer 10, upon receiving the search request, transmits the search term to the server computer 20. The next step, in block 420, the Parse and Cook Query is executed at the server computer 20. The details of the query parsing and cooking process are shown in FIG. 5.

Now refer to FIG. 5.

One advantageous feature of this system is that the customer can enter search requests using simple daily language terms rather than bar code or other types of abstract item codes. A search term is a phrase descriptive of the item the customer is looking for. For example, if the customer wants to find the location of Hershey's Chocolate products, the customer may enter one of the following terms:

Hershey's Chocolate

Hershey's

Chocolate

Hershey

Hersheys

The customer also has the option to specify more explicitly what he is looking for by using structured query, e.g. “BRAND=Hershey's; NAME=Chocolate”. Note that the two expressions are delimited using a semicolon here. Other delimiters may be used in actual implementation. The customer needs to be instructed of which delimiter should be used between expressions. The instruction should also include a list of field names that can be used on the left-hand-side of the expressions. Since the goal for using structured query is to limit the search results, an AND logic operator is assumed between expressions.

It is possible to allow the customer specify Boolean operators between expressions as well as using other more advanced options, such as the use of parenthesis to specify complex logics. However, these advanced options will be overcomplicated for most of the average customers and therefore are not recommended.

To assist customers construct structured queries, it will be helpful to use a dropdown list to show the available search fields. The dropdown list can include searchable field names such as Name, Brand, Model, etc. The customer can select one of the available field names and then type in a value for the field.

As stated before, the Query Parser and Cooker component in FIG. 5 is responsible for parsing and cooking the raw search term entered by the customer. Upon receiving the search term at block 510, the system will create a keyword list memory space to store any keywords generated during the parsing and cooking process.

Next, the system determines whether the search is a simple query or a structured query, as indicated in block 520. This can be done simply by detecting the existence of the equal sign in the search term. If equal sign is detected, then the search is using structured query, otherwise, the search is using simple query. For structured query, the system will go to block 522, parse the query into a list of simplex expressions. For example, the search term “BRAND=Hershey's; NAME=Chocolate” will be parsed into two simplex expressions:

BRAND=Hershey 's

NAME=Chocolate

The process then move to block 570, return the keyword list. The above expressions can be translated to a query containing a list of keywords with attributes, as shown below.

<Query type=“structured”>
<Keyword type=“BRAND”>Hershey 's</Keyword>
<Keyword type=“NAME”>Chocolate</Keyword>

</Query>

Note that XML is used here and in later sections to show the data structure in an easy to read textual format, it should be understood that the data structure to store a query can be implemented using class objects or other ways rather than XML nodes in actual implementation.

At block 520, if the system determines that the search is a simple query. The next step will be block 530 to check if the search term contains multiple words. This can be determined by checking the existence of the space between non-space characters. If the search term contains multiple words, the next step will be block 532 to split the term into individual words and add each word to the keyword list. If the search contains only one word, the system will simply add the original word to the keyword list.

Other processes, such as Soundex, synonym, and typo correction may also be used to maximize the chance that the search results will contain what the customer is looking for. Block 540 does synonym processing and will add the synonyms of the existing keywords to the keyword list. Block 550 does Soundex processing and will add words with similar pronunciation to existing keywords to the keyword list. Block 560 does typo correction processing and will check existing keywords for common typos and add typo-corrected keywords to the list. The above mentioned processes can be performed by either first computer 10 or second computer 20.

At the end of the parsing and cooking process, a prepared query with a list of keywords will be generated. For example, if the customer searches for “Hershey's Chocolate”, the prepared query after block 420 will be:

<Query type=“simple”>
<Original>
   <Keyword>Hershey's Chocolate </Keyword>
</Original>
<Splits>
   <Keyword>Hershey's </Keyword>
   <Keyword>Chocolate</Keyword>
   <Keyword>Hershey</Keyword>
   <Keyword>Hersheys</Keyword>
</Splits>
<Soundex>
   <Keyword>Hersheyz</Keyword>
</Soundex>
<Synonym>
   <Keyword>Chocolaty</Keyword>
</Synonym>

</Query>

Refer now back to FIG. 4.

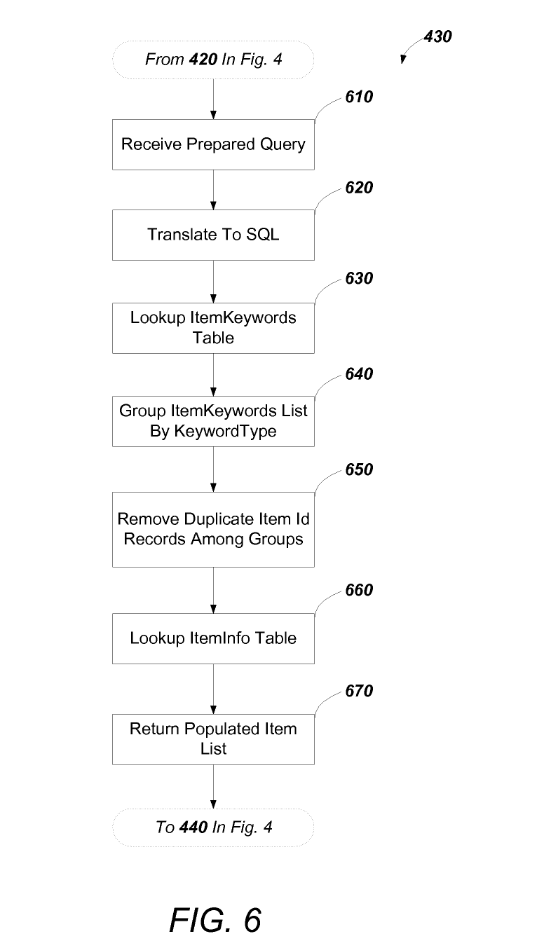

The query prepared at block 420 can then be passed to the next step, block 430, to retrieve item information for all records that match the criteria specified in the query. Details for the item retrieval process are shown in FIG. 6.

Now refer to FIG. 6.

The Item Data Retrieval component 420 is responsible for retrieving item information using the prepared query. At block 610, the component receives the prepared query. In the presently preferred embodiment, the data store 30 is a relational database. Therefore, at the next step, block 620, the prepared query will be translated to a SQL statement. If a keyword in the prepared query includes a type attribute, the type should be reflected in the SQL statement. For example, “<Keyword type=“NAME”>Chocolate</Keyword>” would be translated to “Keyword =‘Chocolate’ AND KeywordType=‘NAME’”.

Next, at block 630, the SQL statement will be executed against the ItemKeywords table 310. The result is a list of ItemKeywords records containing item ids. At block 640, this list of ItemKeywords records will then be grouped according to the type of each keyword. Since multiple keywords are used in the matching process, some item ids may appear more than once in the ItemKeywords list. A clean up process is conducted at block 650 to remove any duplicate item ids in the list. At block 660, the cleaned list of ItemKeywords is joined with ItemInfo table 320. The result of this join is a list of items with descriptive information populated. At block 660, this result is returned, and the process continues to Block 440 in FIG. 4.

Note that the ItemKeywords table 310 and the ItemInfo table 320 can be combined to form a single table. The advantage for this approach is that the step of block 660 to look up item information can be skipped since the item list will already contain descriptive item information. The disadvantage for this approach is that data redundancy will be introduced when combining the two tables.

Note also that when using keyword database, it may be desirable to cook the keywords in the keyword database and put all entries of cooked keywords in the database in order to boost run time performance. This way, some steps of query cooking such as Soundex, synonym, and typo correction can be skipped. The search term can be directly used to query the keyword database without additional cooking. By using this technique, fewer queries will be needed when retrieving item ids from ItemKeywords table 310. A drawback of this approach is that the ItemKeywords table 310 can be significantly larger with the addition of the cooked keyword entries.

Now refer back to FIG. 4.

In the next step, block 440, the list of items retrieved in step 430 will be sent to client computer 10 and displayed to the customer. At block 450, the customer makes selections from the list. The selection is done at client computer 10. The items selected by the customer will be sent to the server 20.

At block 460, executed at the server computer 20, the locations for the selected items will be retrieved. Item locations are stored in the ItemLocation table 330. This information can be retrieved using item ids. The result contains the display fixture id and the shelf id indicating the display fixture and the shelf where the item is located. Properties of the display fixtures and the shelves on these display fixtures can then be retrieved from DisplayFixtures table 346 and Shelfinfo table 348 using the display fixture ids and shelf ids. The dimension and location properties of the display fixtures can be used to highlight the respective area in the store map to show the locations of the selected items.

The preferred way to show item locations to the customer is using maps. In order to display the location information in a map format, the base map data will be retrieved from StoreMap table 342. Since base store map data are relatively static, this data can be cached in the computer's memory to avoid retrieving it from database each time. Depending on the file format of the base map, it is also possible to store only a pointer to the map file in table 342.

The map is generated using data stored in the StoreMap table 342 and DisplayFixtures table 346. The database structure is capable of storing maps for multiple stores. Each store will have a unique id. It is assumed that the customer has already determined which store to shop prior to this step. To generate the map, the system will first retrieve base map data from StoreMap table 342. The base map contains non-selectable features such as walls, entrance, exit, checkout stations, etc. Then the system retrieves all the display fixtures from DisplayFixtures table 346. These display fixtures are put on top of the base map. The position and shape of the fixtures are determined by its location and dimensions. Each display fixture can be labeled using values stored in the Label field in the DisplayFixtures table 346.

At block 470, the generated maps are sent to client computer 10 and presented to the customer.

Presentation of item location may take various formats, such as computer screen, printer print out, and audio announcement. A combination of output formats may be used together to better assist customers.

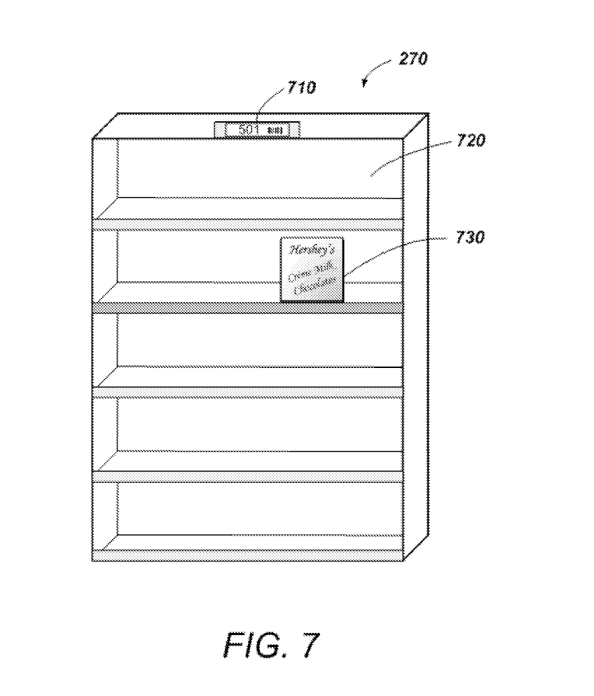

FIG. 7 shows the front view of the highlighted display fixture 270.

Refer now to FIG. 7.

Reference numeral 710 is a label on the display fixture 270. The label 710 may include both human readable information and machine readable symbols such as barcode. The barcode will be helpful for item location data collection. The human readable information includes a code to identify the fixture. Codes used to identify fixtures are texts to help users of the system to memorize the location for the items. A code can be numerical, textual or symbolic. Examples of code are: 12005, Cherry-32, Green-123, Children's Room-3.

Reference numeral 720 indicates the top shelf of the fixture. Reference numeral 730 shows an icon representing the location of an item as placed on the shelf.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

What is claimed is:

1. An item locator system comprising:
a first computer responsive to the commands of a user of said first computer corresponding to a location of a item within an establishment;
the establishment including display fixtures identifiable using an identification code;
a second computer having access to stored data corresponding to the location of the item within the establishment;
said first computer receiving the location of the item from said second computer;
a display fixture for displaying the item;
said first computer upon receiving a request from said user outputs the identification code of the display fixture where the item can be found.

2. An item locator system of claim 1 wherein the display fixture is marked with an identification code.

3. An item locator system of claim 1 wherein the output includes a directional map with the locations of the item marked.

4. An item locator system of claim 1 wherein the output includes audio.

5. An item locator system of claim 1 wherein the output includes printer print out.

6. An item locator system of claim 1, wherein the output includes further information of the location of the item within the display fixture.

7. An item locator system of claim 1, wherein said first computer and said second computer are a single computer.

8. An item locator system as in claim 1, wherein said first computer receives a search term.

9. An item locator system as in claim 8, wherein said first computer or said second computer performs synonym processing on said search term.

10. An item locator system as in claim 8, wherein said first computer or said second computer performs Soundex processing on said search term.

11. An item locator system as in claim 8, wherein said first computer or said second computer performs typo correction on said search term.

12. An item locator system of claim 2 wherein said identification code contains human-readable text.

13. An item locator system of claim 2 wherein said identification code contains machine readable symbols.

14. An item locator system comprising:
a computer responsive to the commands of a user of said computer corresponding to a location of a plurality of items within an establishment;
the establishment including a plurality of display fixtures identifiable using identification codes;
said computer having access to stored data comprising information regarding the location of said plurality of items within the establishment;
said computer responsive to receiving a request from said user displays the identification codes of the display fixtures where the plurality of items can be found.
